(19) United States
(12) Patent Application Publication
(10) Pub. No.: US 2023/0281703 A1
(43) Pub. Date: Sep. 7, 2023

(54) ENHANCED E-COMMERCE AND LIVESTREAM PLATFORM

(71) Applicant: Chenhao Li, Sugar Land, TX (US)

(72) Inventor: Chenhao Li, Sugar Land, TX (US)

(21) Appl. No.: 18/316,807

(22) Filed: May 12, 2023

Related U.S. Application Data
(63) Continuation of application No. PCT/US21/49016, filed on Sep. 3, 2021.
(60) Provisional application No. 63/116,688, filed on Nov. 20, 2020.

(51) Int. Cl. G06Q 30/0601; H04N 21/2187; H04N 21/254; H04N 21/478; G06Q 30/0207; G06F 16/958

(52) U.S. Cl. CPC G06Q 30/0643; H04N 21/2187; H04N 21/2542; H04N 21/47815; G06Q 30/0222; G06F 16/958

(57) ABSTRACT

Devices, systems, and methods are provided for an enhanced online shopping platform having multiple home pages for livestreaming and product pages. A method may include receiving, from a first user of the e-commerce system, a first request to a second user of the e-commerce system to present a livestream of a product sold by the first user; sending first request to the second user; receiving, based on the first request, a second request made by the second user to generate the livestream; generating, based on the second request, a first webpage of the e-commerce system, the first webpage presenting the livestream; receiving a third request made by the second user to present the first address using the first webpage; presenting the first webpage, including the livestream and the first address; receiving a selection of the first address; and re-directing to the product page.

### CROSS-REFERENCE TO RELATED APPLICATION(S)

This application is a continuation of and claims the benefit of PCT Application No. PCT/US2021/049016, filed Sep. 3, 2021, published as WO2022/108642, which claims the benefit of U.S. Provisional Application No. 63/116,688, filed on Nov. 20, 2020, the disclosures of which are incorporated by reference as if set forth in full.

### TECHNICAL FIELD

This disclosure relates to methods, systems, and devices for an enhanced electronic commerce (e-commerce) and livestream platform.

### BACKGROUND

Buyers and sellers want to connect with one another without needing to be at a same physical location. Sellers may present their products, but often may not have a way to generate an audience, and buyers may not be aware of sellers and their products. In addition, virtual settings that connect buyers and sellers may be limited in time, and may not be customized for the buyers and sellers, often limiting buyer and seller opportunities due to limited online sessions. Buyers also may need to open and toggle between multiple windows or tabs to find information about a product and to purchase a product. Sellers may need product promotions to increase sales, therefore, there is need to create an online shopping place where customers can buy together to take bulk price discounts.

### BRIEF DESCRIPTION OF THE DRAWINGS

FIG. 1 illustrates an example environment for an electronic commerce (e-commerce) platform for livestreams and product pages, in accordance with one or more example embodiments of the present disclosure.

FIG. 2 illustrates an example system flow for an e-commence platform for livestreams and product pages, in accordance with one or more example embodiments of the present disclosure.

FIG. 3 illustrates an example process flow using an e-commence platform for livestreams and product pages, in accordance with one or more example embodiments of the present disclosure.

FIG. 4 illustrates an example process flow using an e-commence platform for livestreams and product pages, in accordance with one or more example embodiments of the present disclosure.

FIG. 5 illustrates an example process flow using an e-commence platform for livestreams and product pages, in accordance with one or more example embodiments of the present disclosure.

FIG. 6 illustrates an example process flow using an e-commence platform for livestreams and product pages, in accordance with one or more example embodiments of the present disclosure.

FIG. 7 illustrates an example group buy option using an e-commence platform for livestreams and product pages, in accordance with one or more example embodiments of the present disclosure.

FIG. 8 illustrates an example process flow for a group buy option using an e-commence platform for livestreams and product pages, in accordance with one or more example embodiments of the present disclosure.

FIG. 9 illustrates an example system for an e-commence platform for livestreams and product pages, in accordance with one or more example embodiments of the present disclosure.

FIG. 10 illustrates example interfaces for purchasing a product using an e-commence platform for livestreams and product pages, in accordance with one or more example embodiments of the present disclosure.

FIG. 11 illustrates example interfaces for purchasing a product with a group buy option using an e-commence platform for livestreams and product pages, in accordance with one or more example embodiments of the present disclosure.

FIG. 12 illustrates a flow diagram of a process for using an e-commence platform for livestreams and product pages, in accordance with one or more example embodiments of the present disclosure.

FIG. 13 illustrates a flow diagram of a process for using an e-commence platform for livestreams and product pages, in accordance with one or more example embodiments of the present disclosure.

FIG. 14 is a block diagram illustrating an example of a computing device or computer system upon which any of one or more techniques (e.g., methods) may be performed, in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

### Overview

Example embodiments described herein provide certain systems, methods, and devices for an enhanced e-commerce and livestream platform.

Product livestreams offer a way for buyers and sellers to connect virtually. A seller may present one or multiple products in a livestream that may be viewed by one or multiple buyers. However, livestreams last for a finite time and may present a limited number of products (e.g., what can be shown in a camera's field of view), so a prospective buyer may miss the livestream, a livestream may end while a prospective buyer is still researching a product, and/or a buyer may be interested in other products or brands of a seller whose products are featured in a livestream.

When watching a product livestream, a prospective buyer may want to learn more about a product, the seller of the product, or other products sold by the seller. A seller may want to showcase multiple products and/or brands in a livestream, and may want to have multiple advertisers provide different livestreams with the same or different products and/or brands. In addition, the buyer may want to purchase one or more of the products sold by the seller.

Sellers may be limited in the number of products that they can present during a product livestream. For example, a video presentation may use a video feed with a limited field of view that limits the number of products that may be presented in the product livestream. The seller may have other products that cannot be presented during the product livestream, and may have no convenient way of presenting information to the seller regarding the additional products without requiring the seller to open and maintain multiple windows or tabs as described above.

Buyers and sellers may have location preferences that may not be considered in a virtual setting. Whereas a person may select a local store's physical location from which to purchase an item, a buyer may not be aware of where a product is sold from. Because buyers may have location preferences, such as where their purchased products are from, an online purchase from a particular location based on the buyer's location (e.g., within a same city or state as the buyer), buyers may not be able identify with ease sellers and products that meet the buyers' location preferences.

There is therefore a need for an enhanced virtual environment and method for connecting buyers and sellers for presentation and purchases of products.

Live streaming takes large system capacity, so if an electronic commerce (e-commerce) website includes a large volume of live streaming instances, system performance may be slow. The present disclosure solves this problem by building two parallel functional websites (e.g., a livestream homepage and a product homepage) into one online location, then uses addresses (e.g., hyperlinks) and a message system to connect the livestream webpages (e.g., sub-webpages) to product webpages (e.g., sub-webpages). This way, best technologies can be employed, (e.g. use most suitable technology for building live streaming, then use a different technology to build product pages to ensure superior system performance and offer many flexibilities for operations). The two parallel functioning home pages design also enables a different set of product categories and sub-categories for each home page, and therefore helps users save shopping time while enhancing user experience.

In order to connect these two parallel landing pages (e.g., home pages), the present disclosure provides two levels of user interface: hyperlinks at the landing page level, and hyperlinks at the individual store/product level. Users can click or otherwise select the hyperlinks from the landing page to switch to another functional landing page. A “live streaming view” hyperlink will bring users to live streaming landing page, and a “product view” hyperlink will bring users to product view landing page. Users can click the hyperlink at individual store/product level to switch between the live streaming window of the individual store or the products window of the individual store.

In order to achieve positive live streaming effects on product sales, it may be beneficial to show product information using a webpage that presents a live streaming window. To facilitate the generation of livestreams and their links to product pages, a store owner (e.g., seller of a product) may send (e.g., using a request sent via the messaging system) product information (including an address, such as a hyperlink) to one or more live seller accounts, requesting the live sellers to generate a livestream and include product page addresses in the webpages that present the livestreams. These messages may be provided to the live seller accounts using the message center. The live seller has control of when and what products to present (e.g., using product images and/or addresses provided in the request messages) in the live streaming window by posting these product links from the message center to a live steaming window. In this manner, a seller may rely on multiple livestreaming users to generate livestreams that may feature the seller's products/brands, and may link to the seller's products/brands (e.g., product pages, seller pages, etc.).

Retail businesses often generate product promotions. In order to help increase customer demand of a product, the present disclosure provides a group buy feature with a group buy price that is less than a normal price for a product when the product is purchased a number of times within a limited time duration. The group buy option may be applied at an individual products level. A store owner may log into the e-commerce system using an account identifier, upload the product, specify a regular price and a group buy price, a minimum number of orders required, and maximum time limit to satisfy the minimum number of orders (e.g., based on an aggregate number of orders of a product by one or multiple users). Once the store owner posts the group buy option, the product may be visible on the product view landing page under group buy products category. Any user can click or otherwise select the group buy link from the product page and place an order that is conditional on the number of orders being satisfied within the time limit. Timing may start upon link selection/activation to create motivation for price-sensitive customers to share the product link on social media or otherwise, invite other users to join in order to take price discount. Once the minimum number of orders is reached within the specified time limit, a payment processor automatically may check out all orders in users' virtual shopping carts. Once the group buy order has completed or the time limit has expired, the group buy link may become inactive. Customers' virtual shopping carts with group buy products may be tagged during this process and manual check out may be disabled.

In one or more embodiments, multiple sub-webpages may cater to the unique needs of different businesses. For any sub-website, there may be two functional websites: a livestream website and an e-commerce website. The e-commerce website may be further integrated with a group-purchase option. The sub-websites may be linked to a same customer database, allowing customers to identify products from different websites at once. In this manner, the multiple sub-website structure enables an unlimited range of products to be connected to a livestream. In addition, the live-selling activities may be separated from product ownership, allowing users to engage third parties to promote products on the promoters' user accounts (e.g., without divulging confidential information of the sellers). The multiple sub-website design also allows for different front-end designs to make the platform more user-friendly.

One example improvement provided by the enhancements herein is how a livestream may showcase only a limited number of products in a livestream window, preventing customers from purchasing items not shown in the livestream and linked to corresponding product pages. Another example improvement is that the multiple sub-website design allows for a seller to upload its entire inventory into the e-commerce portal, and contract a promoter to perform a livestream event that allows the promoter to showcase products, communicate with prospective buyers in real-time, and allows the prospective buyers to browse products from the entire inventory rather than being limited to the products shown in the livestream.

The above descriptions are for purposes of illustration and are not meant to be limiting. Numerous other examples, configurations, processes, etc., may exist, some of which are described in greater detail below. Example embodiments will now be described with reference to the accompanying figures.

### Illustrative Processes and Use Cases

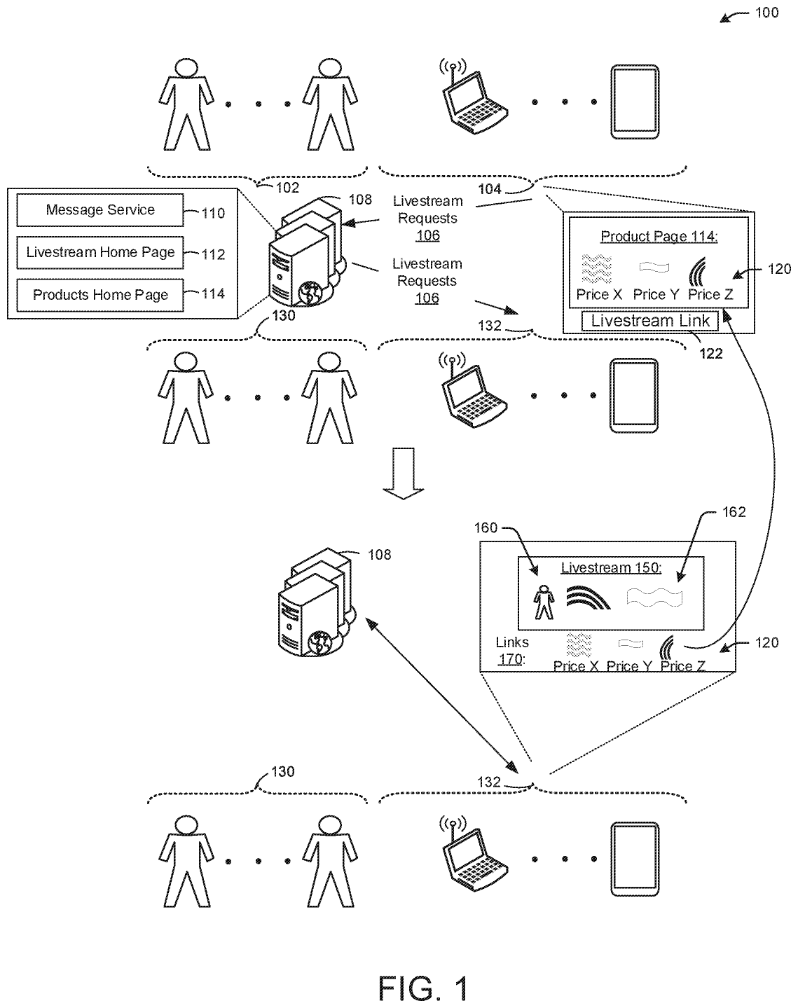

FIG. 1 illustrates an example environment 100 for an electronic commerce (e-commerce) platform for livestreams and product pages, in accordance with one or more example embodiments of the present disclosure.

Referring to FIG. 1, users 102 (e.g., product sellers) of devices 104 may communicate with (e.g., send livestream requests 106 to) one or more remote devices 108 (e.g., servers, a cloud-based network, etc.) that facilitate an e-commerce system. The one or more remote devices 108 may include a message service 110 that allows the users 102 to send and receive messages to one another and to other users of the e-commerce system. The one or more remote devices 108 may include multiple home pages, such as a livestream home page 112 and a products home page 114. In this manner, when the users 102 access the e-commerce system (e.g., via a uniform resource locator—URL—address of the e-commerce system), a page may be displayed with links to both the livestream home page 112 and to the products home page 114. The devices 104 may display a product page 114 that may present products 120 (e.g., sold by any of the users 102) and a livestream link 122 (e.g., a URL to a livestream page) to allow users to find more information about the products 120, add the products 120 to a virtual shopping cart for purchase, or access a product livestream.

Still referring to FIG. 1, the message service 110 may receive the livestream requests 106 and send them to users 130 (e.g., livestream users, such as paid spokespeople for the products 120) of devices 132 that access the e-commerce system provided by the one or more remote devices 108. The livestream requests 106 may identify the users 130 to which the livestream requests 106 are to be sent, and may include addresses (e.g., URLs), product names, product images, etc. (e.g., for the products 120) for the products that the users 102 are requesting the users 130 to present using livestream events. The devices 132 may receive the livestream requests 106 as messages to present to the users 130, and the users 130 may choose to initiate livestream events and add the product addresses from the livestream requests 106 to the livestream events. For example, the users 130 may provide a request to the user devices 132 to generate a livestream event 150, and the one or more remote devices 108 may generate livestream page data for the livestream event 150 to be presented using the devices 132. The livestream event 150 may include a video feed (e.g., stream) of a user 160 (e.g., one of the users 130) and one or more products 162 (e.g., which may be products of one of the users 102). The livestream event 150 may be presented using a page that also presents links 170 to the products 120 that were provided in the livestream requests 106. In this manner, when another user accesses the livestream event 150 (e.g., from the livestream home page 112 or using a URL to the livestream event 150), the products 120 may be displayed as images with other information (e.g., price, seller, etc.), and when a user selects one of the products 120 (e.g., via a touch, click, etc.), the user may be re-directed to the corresponding product page (e.g., the product page 114). In this manner, users who access the livestream home page 112 may be presented with current or previously recorded livestream events such as the livestream event 150, and may select any of the livestreams as options for presentation. When a selected livestream is presented, it may be presented along with information and links for other products that otherwise may not have been presented during the livestream (e.g., because the products were not physically present for the livestream feed, could not fit within a camera's field of view, etc.).

In one or more embodiments, the livestreams presented by the livestream home page 112 or the product pages presented by the products home page 114 may be based on a preferred location of a viewer (e.g., a shopper). Buyers and sellers may have location preferences that may not be considered in a virtual setting. Whereas a person may select a local store's physical location from which to purchase an item, a buyer may not be aware of where a product is sold from. Because buyers may have location preferences, such as where their purchased products are from, an online purchase from a particular location based on the buyer's location (e.g., within a same city or state as the buyer), buyers may not be able identify with ease sellers and products that meet the buyers' location preferences.

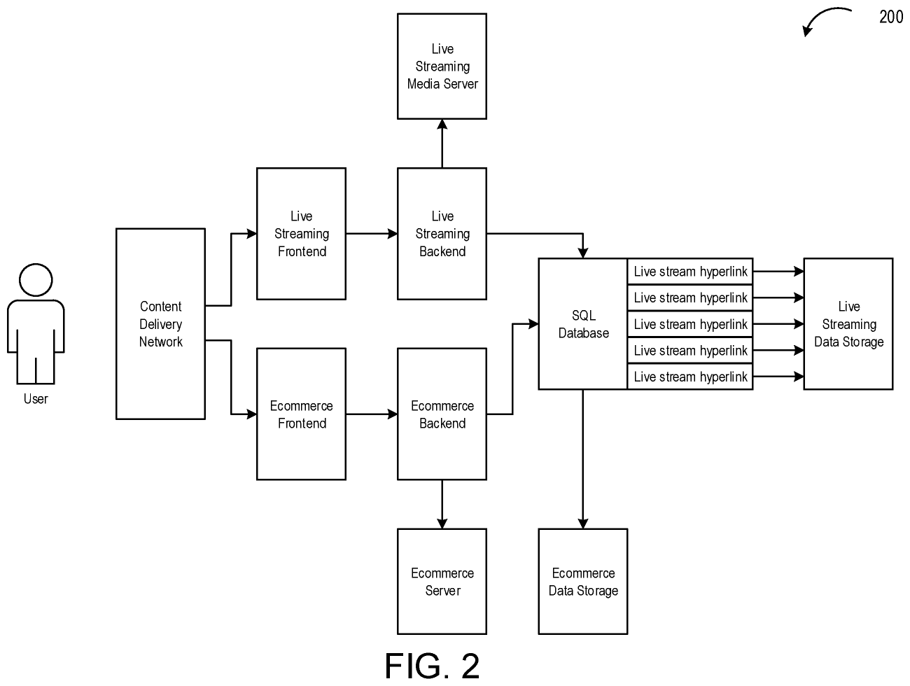

FIG. 2 illustrates an example system flow 200 for an e-commence platform for livestreams and product pages, in accordance with one or more example embodiments of the present disclosure.

Referring to FIG. 2, a user may access the e-commerce platform (e.g., a webpage, mobile application page, etc.) via a content delivery network that provides dual home pages (e.g., a livestreaming front end for the livestream home page 112 of FIG. 1 and an e-commerce front end for the products home page 114 of FIG. 1). The respective home pages may have back ends to connect to respective servers for livestreaming data and product data, and may access a database (e.g., using structured query language or otherwise) with links to livestreams and product pages stored in respective livestreaming and product page data storage.

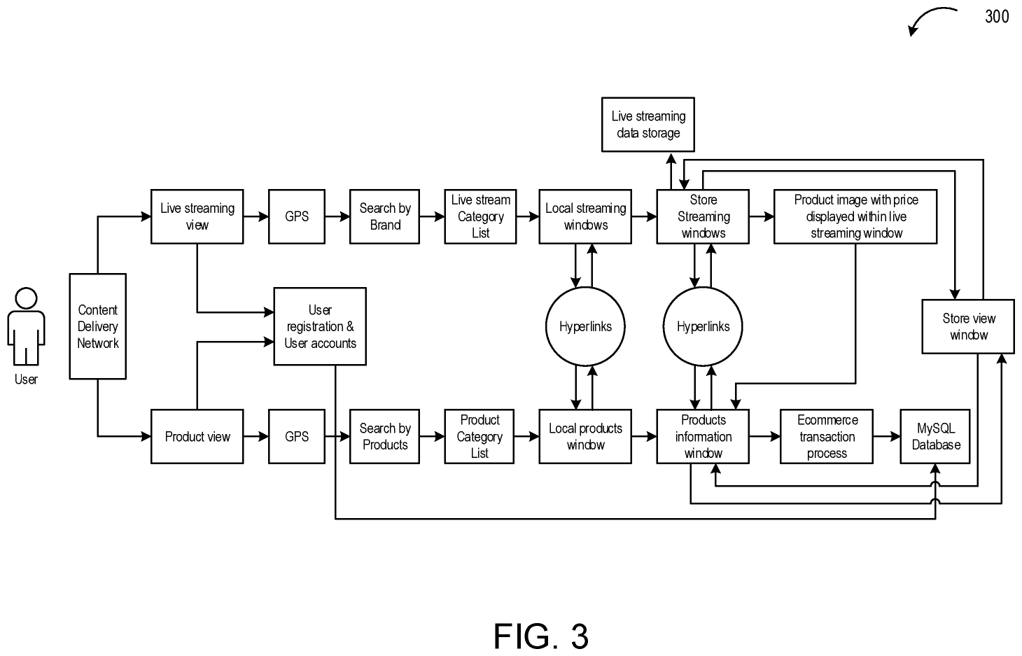

FIG. 3 illustrates an example process flow 300 using an e-commence platform for livestreams and product pages, in accordance with one or more example embodiments of the present disclosure.

Still referring to FIG. 3, the process flow 300 may allow a user (e.g., the users 102, the users 130 of FIG. 1) to register user accounts via the one or more remote devices 108 of FIG. 1 as user accounts for sellers and/or live streamers. The users who access the e-commerce system (e.g., via webpage, product page, etc.) may search for products by brand, seller, location, etc. The search may identify livestreams and/or product pages that the users may select for presentation. A page may include first-level links to the livestream home page 112 of FIG. 1 and to the products home page 114 of FIG. 1. Once a user accesses the livestream home page 112 or the products home page 114, presentation of the respective home page may include second-level links to livestreaming pages and/or products pages (e.g., the product page 114 of FIG. 1, which may be a page for a particular product or a seller's page that includes multiple products of the seller). When a second-level link is selected, a user may be re-directed to the corresponding livestream page or product page. In this manner, users may view livestreams and product pages, and may purchase products from product pages provided by the e-commerce platform.

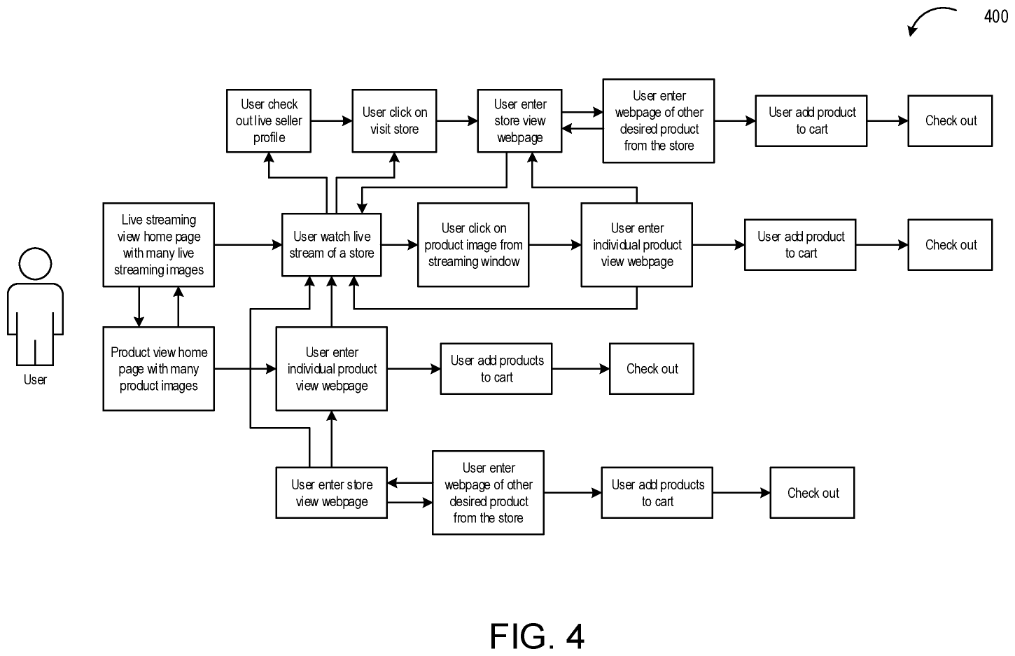

FIG. 4 illustrates an example process flow 400 using an e-commence platform for livestreams and product pages, in accordance with one or more example embodiments of the present disclosure.

Referring to FIG. 4, the process flow 400 allows for users (e.g., the users 102, the users 130 of FIG. 1) to navigate between the livestream home page 112 of FIG. 1 and to the products home page 114 of FIG. 1. When a user selects a product image (e.g., the links 170 of FIG. 1) from a livestream page, the user may be re-directed to a product page where the user may see a product and/or other products by a seller, may add products to a virtual shopping cart, and may check out by purchasing products from the virtual shopping cart. As shown in FIG. 1, livestream pages may link to product pages. Additionally, a product page may link to a livestream (e.g., of the same seller who operates the product page).

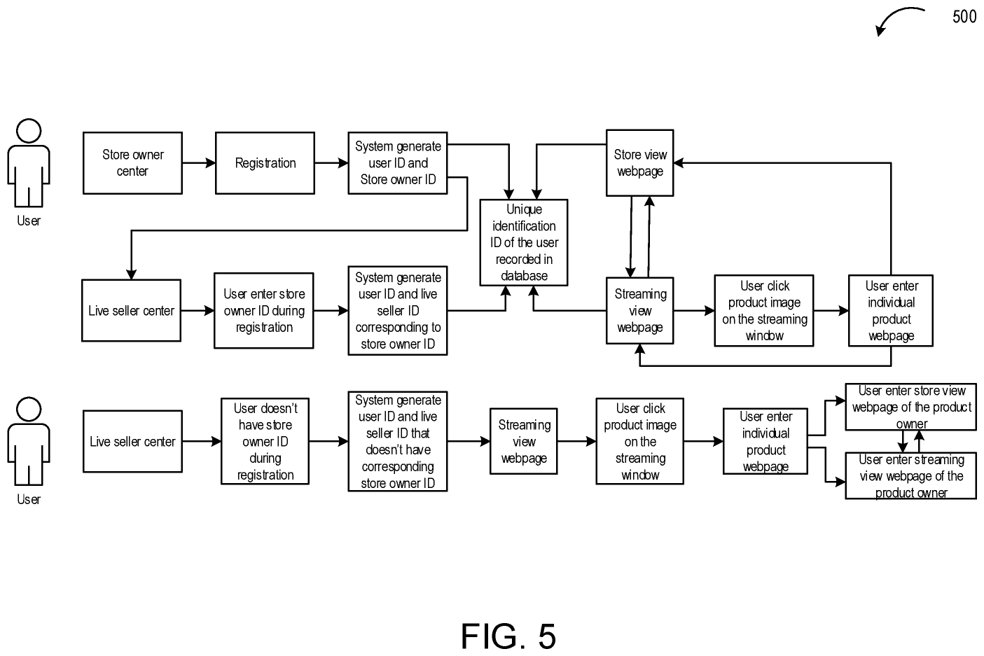

FIG. 5 illustrates an example process flow 500 using an e-commence platform for livestreams and product pages, in accordance with one or more example embodiments of the present disclosure.

Referring to FIG. 5, the users on the bottom of the figure may be sellers (e.g., the users 130 of FIG. 1), so their user accounts may be for product advertisers, and these users may not have a corresponding product owner/seller accounts. In contrast, the users at the top of the figure may represent product owners/sellers (e.g., the users 102 of FIG. 1). In this manner, a product advertiser (e.g., a celebrity) may advertise for multiple products for one or more sellers using one or multiple livestreams. The product owners/sellers may have user accounts that have corresponding product advertiser accounts with which to generate their own livestreams. In this manner, a product page (e.g., the product page 114 of FIG. 1) may include a link to a livestream conducted by the seller (e.g., the product page 114 may be operated by a seller, and may link to a livestream operated by the same seller).

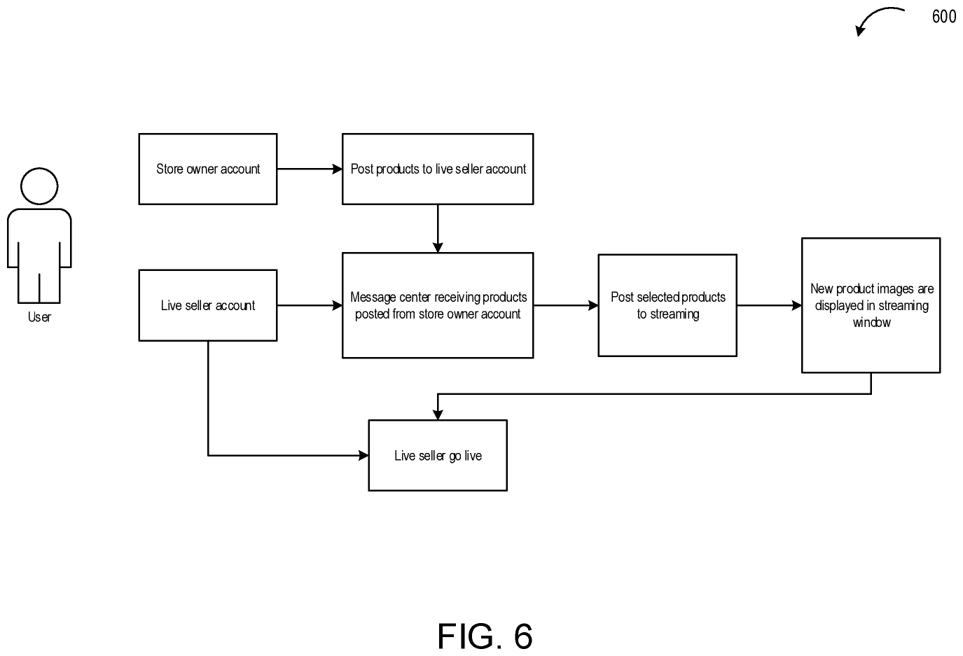

FIG. 6 illustrates an example process flow 600 using an e-commence platform for livestreams and product pages, in accordance with one or more example embodiments of the present disclosure.

Referring to FIG. 6, store owner/product seller accounts may be separated from live seller/advertiser accounts to enable store owner/product seller accounts to control which products are advertised by which live sellers/advertisers and when. For example, the livestream requests 106 of FIG. 1 may include the products and links to a product page where the products are presented so that a live seller/advertiser may “go live” by generating a livestream in which the requested products are shown/linked during the livestream.

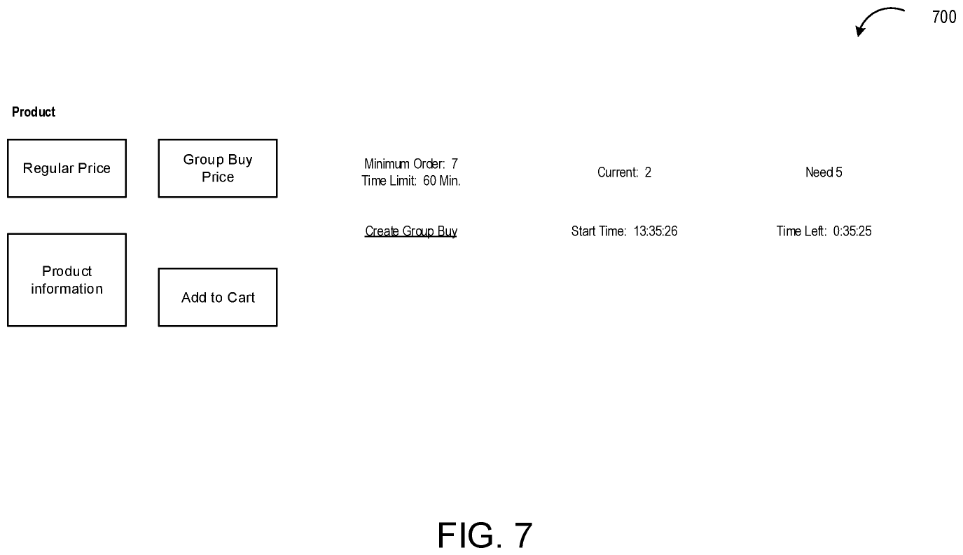

FIG. 7 illustrates an example group buy option 700 using an e-commence platform for livestreams and product pages, in accordance with one or more example embodiments of the present disclosure.

Referring to FIG. 7, the group buy option 700 may be presented as a group buy price that may be different than a regular price of a product (e.g., the group buy price may be discounted). Other information about the product may be presented (e.g., specifications, user reviews, etc.), along with an option to add the product to a virtual shopping cart. The group buy criteria also may be presented, and may include a minimum number of orders of the product or products that need to be completed within a threshold amount of time (e.g., 60 minutes, as shown), the number of current purchases, the number of remaining purchases needed to complete a transaction using the group buy price, a start time for the group buy option 700 and a remaining time for the group buy option 700. When a first user clicks or otherwise selects the group buy link using the group buy option 700, the group buy link will be triggered. —Any users may add the product to a virtual shopping cart at the group buy price during the remaining time. In this manner, the group buy option 700 is completed conditionally based on whether the criteria are satisfied.

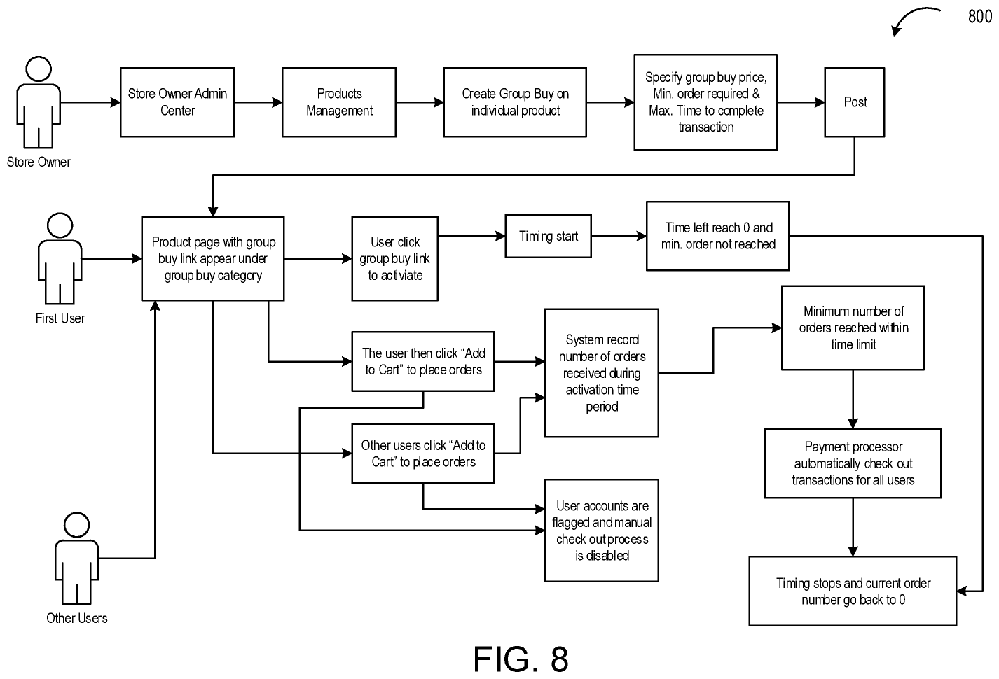

FIG. 8 illustrates an example process flow 800 for a group buy option using an e-commence platform for livestreams and product pages, in accordance with one or more example embodiments of the present disclosure.

Referring to FIG. 8, the process flow 800 shows the process by which the group buy option 700 of FIG. 7 may be used. A store owner (e.g., the users 102 of FIG. 1) may generate a group buy option for one or more products, and may set the group buy criteria, such as price, number of orders required, a time to exercise the group buy option, etc., and may select the time at which the group buy option is posted on a product page. A first user may visit the product page and select the group buy option, starting the limited time period for the availability of the group buy option, then add a product to virtual shopping cart. Other users may visit the product page and add the product to virtual shopping cart. As users add the products to their cart with the group buy option, they may be presented with the updated criteria, such as the remaining number of orders needed to exercise the option. When the required number of orders has been reached within the specified time, the transactions may be automatically triggered by the e-commerce system. The timer and current order number may be reset to zero after the group buy option has been exercised.

In one or more embodiments, the normal price is presented along with the group buy price for comparison only, so the discounted price (e.g., group buy price) is the only active price for the transaction. Once a first user clicks or otherwise selects an option to create a group buy option, the selection will activate the timer and sales count. When total number of orders reach the minimum required within the time limit, the online payment processor will automatically check out orders at the group buy price for all participating shopping cards. If a user is willing to purchase at the regular (e.g., non-group buy) price, the user may have to visit the online store (e.g., product page) and check out from another webpage of the product with regular price. The conditional group buy price feature enhances user experience.

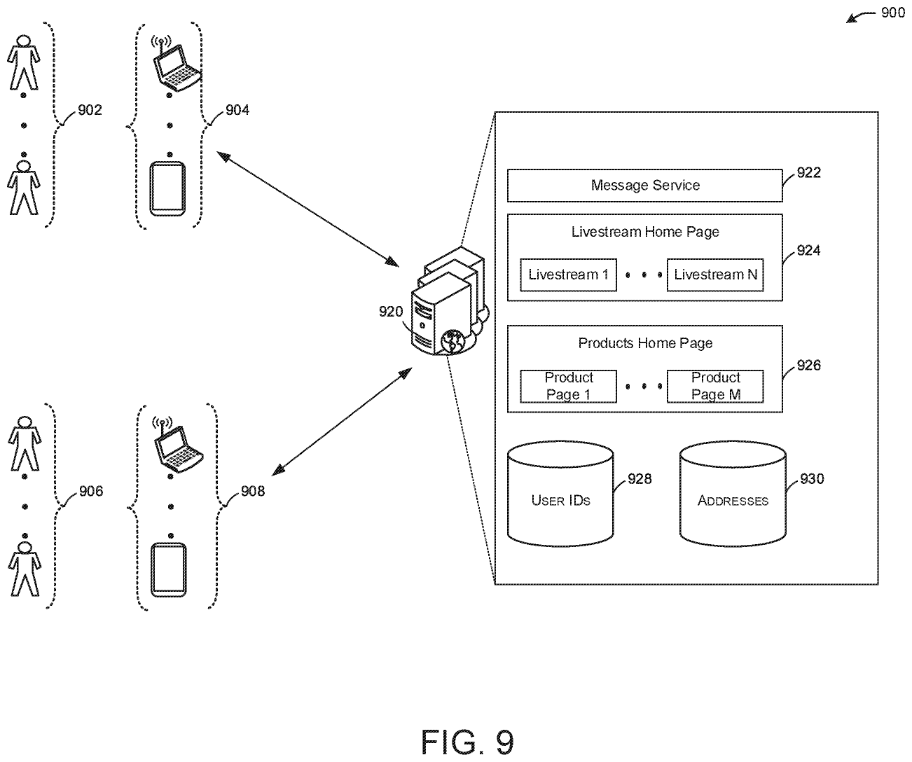

FIG. 9 illustrates an example system 900 for an e-commence platform for livestreams and product pages, in accordance with one or more example embodiments of the present disclosure.

Referring to FIG. 9, users 902 of devices 904 (e.g., similar to the users 102 of the devices 104 of FIG. 1) may communicate with users 906 of devices 908 (e.g., similar to the users 130 of the devices 132 of FIG. 1) to generate and present product pages and livestreams using an e-commerce system provided by one or more remote devices 920 (e.g., similar to the one or more remote devices 108 of FIG. 1). For example, the users 902 may be sellers/product owners who may request (e.g., using the livestream requests 106 of FIG. 1) advertisers (e.g., the users 906) to generate livestreams that feature products of the sellers/product owners (e.g., in the livestream, or as the links 170 of FIG. 0.1). The one or more remote devices 920 may include a message service 922 for receiving and sending messages between the users and their respective accounts. The one or more remote devices 920 may include a livestream home page 924 with multiple livestream options presented to any user who visits the e-commerce page, and may include a products home page 926 with multiple product pages (e.g., operated by the users 902) presented to any user who visits the e-commerce page. The one or more remote devices 920 may maintain user identifiers 928 in a data storage to authenticate the users, direct messages between users, and to identify product pages and/or livestreams operated by the users. The one or more remote devices 920 may maintain addresses (e.g., URLs or otherwise) of product pages and livestreams so that the addresses may be included in links and messages.

In one or more embodiments, a page may be displayed (e.g., using the devices 904 and/or the devices 908) with links to both the livestream home page 924 and to the products home page 926. The devices may display a product page (e.g., the product page 114 of FIG. 1) that may present products (e.g., sold by any of the users 902) and a livestream link (e.g., the livestream link 122 of FIG. 1 based on the addresses 930 of livestreams operated by a user ID of the user IDs 928) to allow users to find more information about the products, add the products to a virtual shopping cart for purchase, or access a product livestream.

In one or more embodiments, the message service 922 may receive livestream requests and send them to the users 906. The livestream requests 106 may identify the users 130 to which the livestream requests may include addresses (e.g., the addresses 930), product names, product images, etc. (e.g., for the products 120 of FIG. 1) for the products that the users 902 are requesting the users 906 to present using livestream events. The devices 908 may receive the livestream requests as messages to present to the users 906, and the users 906 may choose to initiate livestream events and add the product addresses from the livestream requests to the livestream events. For example, the users 906 may provide a request to the devices 908 to generate a livestream event (e.g., Livestream N), and the one or more remote devices 108 may generate livestream page data for the livestream event to be presented using the devices 904 and/or 908. The livestream event may include a video feed (e.g., stream) of a user (e.g., a presenter, such as a celebrity) and one or more products (e.g., which may be products of one of the users 902). The livestream event may be presented using a page that also presents links to the products that were provided in the livestream requests. In this manner, when another user accesses the livestream event (e.g., from the livestream home page 924 or using a URL to the livestream event), the products may be displayed as images with other information (e.g., price, seller, etc.), and when a user selects one of the products (e.g., via a touch, click, etc.), the user may be re-directed to the corresponding product page (e.g., product page M). In this manner, users who access the livestream home page 924 may be presented with current or previously recorded livestream events such as the livestream event, and may select any of the livestreams as options for presentation. When a selected livestream is presented, it may be presented along with information and links for other products that otherwise may not have been presented during the livestream (e.g., because the products were not physically present for the livestream feed, could not fit within a camera's field of view, etc.).

In one or more embodiments, the devices 902, the devices 908, and/or the one or more remote devices 920 may include a personal computer (PC), a smart home device, a wearable wireless device (e.g., bracelet, watch, glasses, ring, strap/band, patch, bandage, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, a media player, a smartphone, or the like.

The devices 902, the devices 908, and/or the one or more remote devices 920 may be configured to communicate via communications networks, wirelessly or wired (e.g., the same or different wireless communications networks). The communications networks may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, the communications networks may have any suitable communication range associated therewith and may include, for example, global networks (e.g., the Internet), metropolitan area networks (MANs), wide area networks (WANs), local area networks (LANs), or personal area networks (PANs). In addition, communications networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

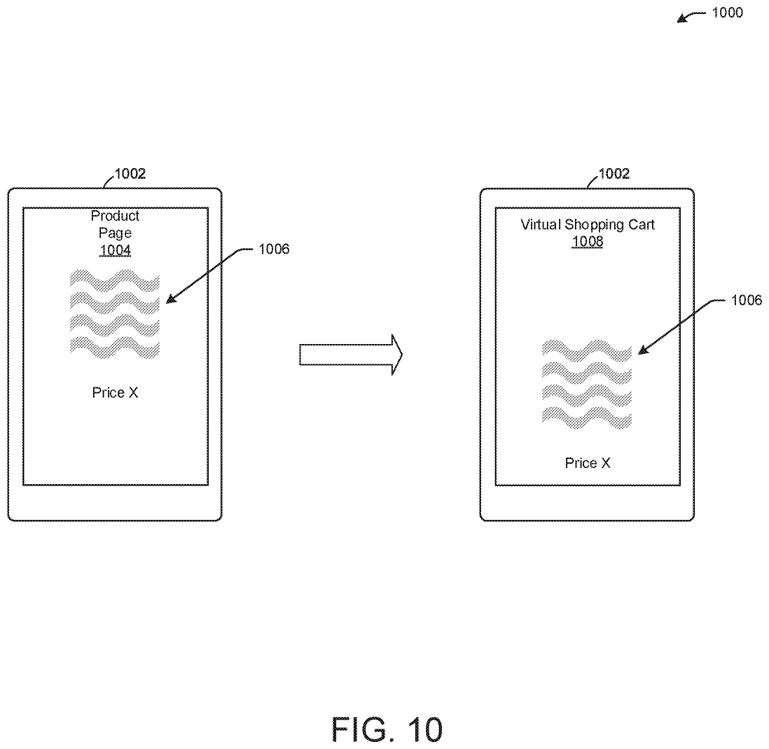

FIG. 10 illustrates example interfaces 1000 for purchasing a product using an e-commence platform for livestreams and product pages, in accordance with one or more example embodiments of the present disclosure.

Referring to FIG. 10, a device 1002 (e.g., similar to the devices 904 and the devices 908 of FIG. 9) may present a product page 1004 (e.g., similar to the product page 114 of FIG. 1) that may include a presentation of one or more products 1006 and a purchase price. When the one or more products 1006 are selected, a virtual shopping cart 1008 may be generated (e.g., by the one or more remote devices 920 of FIG. 9) for presentation using the device 1002. The virtual shopping cart 1008 may allow for a transaction of the one or more products 1006 based on the purchase price.

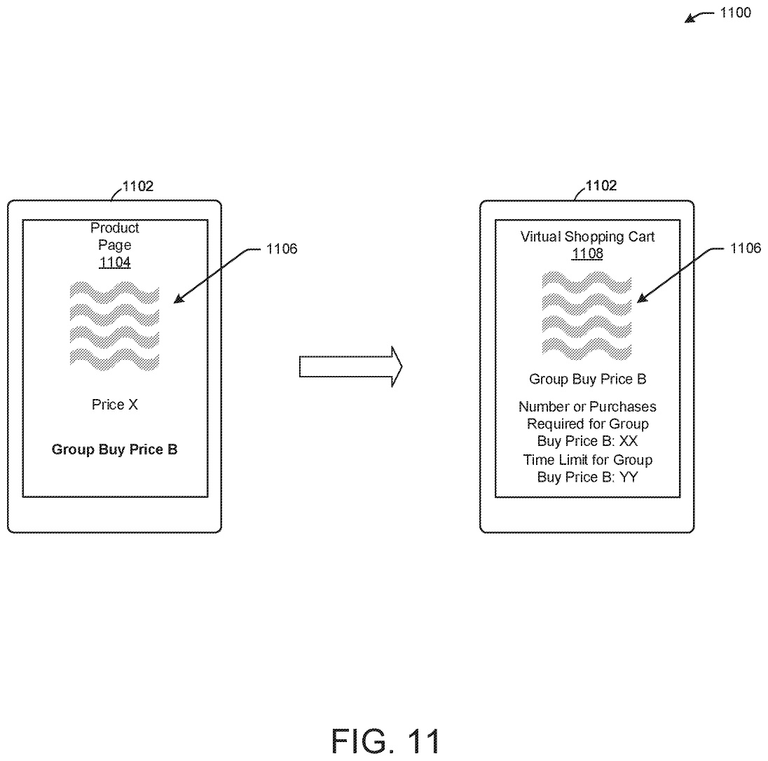

FIG. 11 illustrates example interfaces 1100 for purchasing a product with a group buy option using an e-commence platform for livestreams and product pages, in accordance with one or more example embodiments of the present disclosure.

Still referring to FIG. 11, the device 1102 (e.g., similar to the devices 904 and the devices 908 of FIG. 9) may present a product page 1104 (e.g., similar to the product page 114 of FIG. 1) that may include a presentation of a group buy product 1106, a normal purchase price, and a group buy price (e.g., similar to FIGS. 7 and 8). When the group buy link is selected, a system (e.g., the one or more remote devices 920 of FIG. 9) may start to count total number of orders in the virtual shopping cart and the group buy timing, (e.g., by the one or more remote devices 920 of FIG. 9) for presentation using the device 1102. The virtual shopping cart 1108 may allow for a transaction of the products 1106 based on the group buy price. The group buy criteria may be presented until the criteria are satisfied by other selections of the products 1106 using the group buy price. When the group buy criteria have been satisfied, the group buy transaction may be exercised automatically by facilitating the transaction of the products 1106 according to the group buy price.

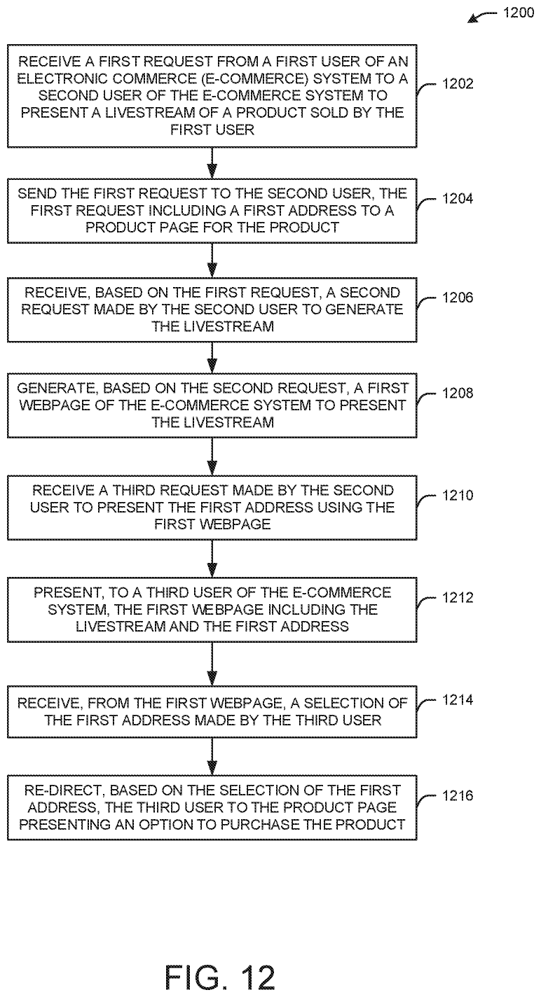

FIG. 12 illustrates a flow diagram of a process 1200 for using an e-commence platform for livestreams and product pages, in accordance with one or more example embodiments of the present disclosure.

At block 1202, a device (e.g., the one or more remote devices 920 of FIG. 9) may receive a first request (e.g., the livestream requests 106 of FIG. 1) of a first user of an e-commerce system having dual home pages (e.g., the livestream home page 924 and the products home page 926 of FIG. 9). The e-commerce system may be an online or mobile platform accessible by multiple devices (e.g., the devices 904 and 908 of FIG. 9), allowing users to access a landing page with the multiple home pages, and allowing authenticated users (e.g., sellers/product owners and advertisers) to send messages. The messages, such as the first request, may be received by the message service 922 of FIG. 9, for example, and may identify products that a seller/product owner is requesting to be included in a livestream. The first request may identify advertisers as recipients of the first request.

At block 1204, the device may send the first request to a second user identified by the request. The second user may be an advertiser who uses the e-commerce platform and who may generate livestreams in exchange for pecuniary value from sellers/product owners. Using the messaging service 922, the device may send the first request and the relevant product information, such as the products, product images, links, prices, and the like as provided by the first request or identified by the device based on the requested products to include in a livestream. The first request may not include the first user's account information. Instead, the second user may be requested by the first request to user the second user's account to generate a livestream for one or more products sold by the first user. The livestream may show some of the products sold by the first user, and may include links to product pages for products both shown and not shown in the livestream.

At block 1206, the device may receive, based on the first request, a second request made by the second user to generate the livestream using the second user's account. In response to the first request, the second user's device (e.g., the devices 908) may present the first request to the second user, providing an option (e.g., an offer) to the second user to generate a livestream that shows, either in the livestream video feed or as links (e.g., the links 170 of FIG. 1), the requested products of the seller/product owner. When the second user selects an option to generate a livestream based on the first request and its requested products, the device may process the request.

At block 1208, the device may generate, based on the second request, a first webpage of the e-commerce system to present the livestream (e.g., as shown in the livestream event 150 page in FIG. 1). The livestream may be based on a video camera feed of the second user and any products shown within the camera's field of view.

At block 1210, the device may receive a third request from the second user to present the address of the products included in the first request (e.g., a URL to the products page of the products). In this manner, the second user may generate the livestream and then add the address of the requested products, or may have the livestream generated with the address included (e.g., block 1208 and block 1210 may be flipped in order). Accordingly, the first webpage may be presented at block 1212 (e.g., may send the data to user devices for presentation) the livestream along with links to other products that may or may not be shown in the video feed of the livestream. The data for the first webpage may be provided to any user device that accesses the first webpage (e.g., using a URL or other address of the first webpage). The livestream may not be able to show every product available at the product pages for sale by the first user, so the livestream may include links to addresses of products both shown and not shown in the livestream.

At block 1214, the device may receive, from the first webpage, a selection of the address of one of the products of the first request (e.g., whether the product is shown in the livestream or is not shown in the livestream, but is sold by the first user). For example, a third user who accesses the first webpage may select (e.g., click, touch, etc.) a product link presented by the first webpage, and the link may embed the address, causing a re-direction at block 1216 to the corresponding URL or other address of the product page. The product page may be presented to the third user and may be accessible under the product home page of the e-commerce platform (e.g., when a user selects the product home page, product pages may be presented, such as the product page). From the product page, the third user may add the product to a virtual shopping cart using a normal purchase price or a group buy option. Example product pages with pricing data are shown in FIGS. 10 and 11.

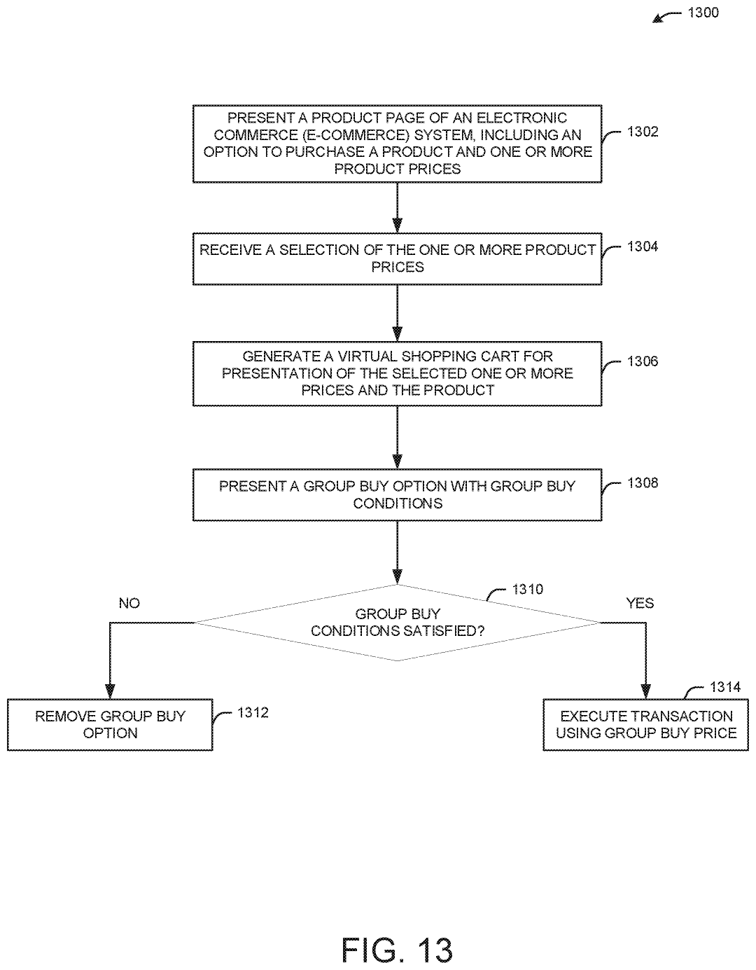

FIG. 13 illustrates a flow diagram of a process 1300 for using an e-commence platform for livestreams and product pages, in accordance with one or more example embodiments of the present disclosure.

At block 1302, a device (e.g., the one or more remote devices 920 of FIG. 9) may facilitate presentation of a product page (e.g., the product page 114 of FIG. 1) of an e-commerce system. The product page may have an option to purchase one or more products at a regular and/or group buy price (e.g., FIGS. 10 and 11).

At block 1304, the device may receive a selection of the one or more product prices, either the regular price or group buy price (e.g., as shown in FIGS. 10 and 11). The user selection may be made by click, touch, gesture, voice input, etc. The selection may be received by the device (e.g., from a client device that presents the product page).

At block 1306, the device may generate a virtual shopping cart for presentation by the client device. The device may send the virtual shopping cart page data and the product price to the client device for presentation (e.g., as shown in FIGS. 10 and 11).

At block 1308, the device may facilitate presentation of the group buy conditions by sending the group buy conditions to the client device for presentation. The conditions (criteria) may include price, number of purchases, and a time limit. The group buy priee transaction may not be exercised until the conditions are satisfied.

At block 1310, the device may determine whether the group buy conditions are satisfied. The device may determine the number of times that the group buy price for a product or products have been selected within the timeframe (e.g., based on user selections across multiple client devices). When the group buy option conditions are not satisfied within the timeframe (e.g., the number of requested purchases using the group buy option does not exceed the required number of purchases), the process 1300 may continue to block 1312, where the group buy option may be removed for all users who selected it, in which case the users may have the option to re-initiate a group buy option if available, or purchase the product at the normal price from a different address. When the group buy conditions are satisfied within the timeframe (e.g., the number of requested purchases using the group buy option exceeds the required number of purchases), the process 1300 may continue to block 1314, where the transactions may be initiated automatically using the group buy price.

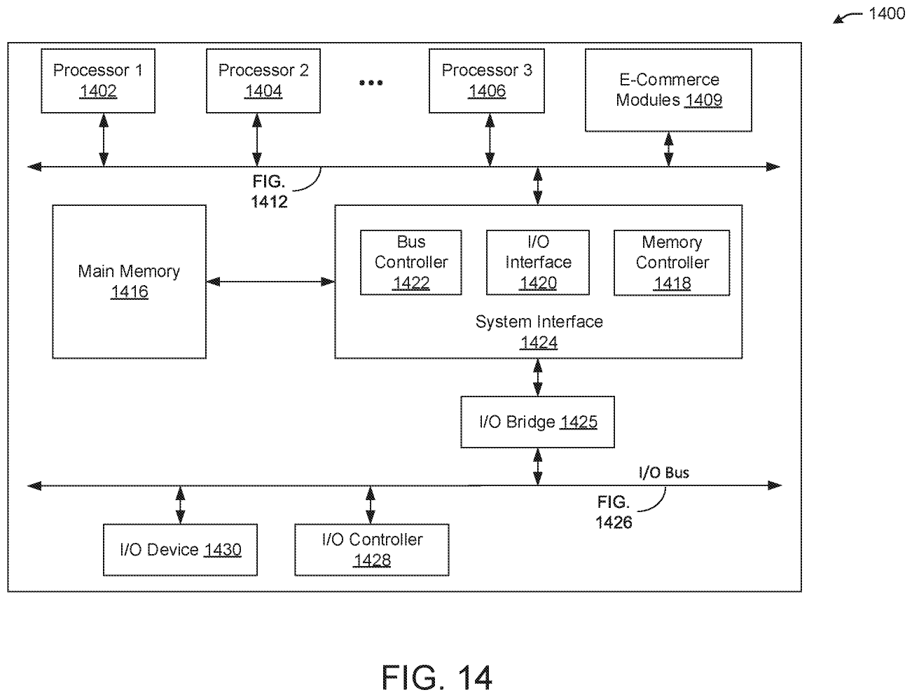

FIG. 14 is a block diagram illustrating an example of a computing device or computer system 1400 upon which any of one or more techniques (e.g., methods) may be performed, in accordance with one or more example embodiments of the present disclosure.

For example, the computing system 1400 of FIG. 14 may represent the devices 904 and/or 908 of FIG. 9, and therefore may facilitate the generation of webpages with product pages, livestreams, messaging, and the like. The computer system (system) includes one or more processors 1402-1406 and one or more e-commerce modules 1409 (e.g. capable of performing the operations of the preceding figures, including FIG. 12 and FIG. 13). Processors 1402-1406 may include one or more internal levels of cache (not shown) and a bus controller (e.g., bus controller 1422) or bus interface (e.g., I/O interface 1420) unit to direct interaction with the processor bus 1412.

Processor bus 1412, also known as the host bus or the front side bus, may be used to couple the processors 1402-1406 with the system interface 1424. System interface 1424 may be connected to the processor bus 1412 to interface other components of the system 1400 with the processor bus 1412. For example, system interface 1424 may include a memory controller 1418 for interfacing a main memory 1416 with the processor bus 1412. The main memory 1416 typically includes one or more memory cards and a control circuit (not shown). System interface 1424 may also include an input/output (I/O) interface 1420 to interface one or more I/O bridges 1425 or I/O devices 1430 with the processor bus 1412. One or more I/O controllers and/or I/O devices may be connected with the I/O bus 1426, such as I/O controller 1428 and I/O device 1430, as illustrated.

I/O device 1430 may also include an input device (not shown), such as an alphanumeric input device, including alphanumeric and other keys for communicating information and/or command selections to the processors 1402-1406. Another type of user input device includes cursor control, such as a mouse, a trackball, or cursor direction keys for communicating direction information and command selections to the processors 1402-1406 and for controlling cursor movement on the display device.

System 1400 may include a dynamic storage device, referred to as main memory 1416, or a random access memory (RAM) or other computer-readable devices coupled to the processor bus 1412 for storing information and instructions to be executed by the processors 1402-1406. Main memory 1416 also may be used for storing temporary variables or other intermediate information during execution of instructions by the processors 1402-1406. System 1400 may include read-only memory (ROM) and/or other static storage device coupled to the processor bus 1412 for storing static information and instructions for the processors 1402-1406. The system outlined in FIG. 14 is but one possible example of a computer system that may employ or be configured in accordance with aspects of the present disclosure.

According to one embodiment, the above techniques may be performed by computer system 1400 in response to processor 1404 executing one or more sequences of one or more instructions contained in main memory 1416. These instructions may be read into main memory 1416 from another machine-readable medium, such as a storage device. In alternative embodiments, circuitry may be used in place of or in combination with the software instructions. Thus, embodiments of the present disclosure may include both hardware and software components.

Various embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as, but not limited to, source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; a flash memory, etc.

A machine-readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, solid state devices (SSDs), and the like. The one or more memory devices (not shown) may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 616, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Example 1 may be a method comprising: receiving, by at least one processor of an electronic commerce (e-commerce) system comprising a first home page presenting product livestreams and a second home page presenting product pages, from a first user of the e-commerce system, a first request to a second user of the e-commerce system to present a livestream of a product sold by the first user; sending, by the at least one processor, the first request to the second user, the first request comprising a first address to a product page for the product, the product page operated by the first user and presented using the second home page; receiving, by the at least one processor, based on the first request, a second request made by the second user to generate the livestream using the e-commerce system; generating, by the at least one processor, based on the second request, a first webpage of the e-commerce system, the first webpage presenting the livestream and operated by the second user, and the first webpage presented using the first home page; receiving, by the at least one processor, a third request made by the second user to present the first address using the first webpage; presenting, by the at least one processor, to a third user of the e-commerce system, the first webpage, wherein the presentation of the first webpage comprises the livestream and the first address; receiving, by the at least one processor, from the first webpage, a selection of the first address made by the third user; and re-directing, by the at least one processor, based on the selection of the first address, the third user to the product page, wherein the product page presents an option to purchase the product and a second address to a second webpage presenting a second livestream operated by the first user.

Example 2 may include the method of example 1 and/or some other example herein, wherein the first request further comprises a third address to a second product page for a second product sold by the first user, the second product page operated by the first user and presented using the second home page.

Example 3 may include the method of example 2 and/or some other example herein, wherein the second address is absent from the presentation of the first webpage.

Example 4 may include the method of example 2 and/or some other example herein, further comprising receiving a fourth request made by the second user to present the second address using the first webpage, wherein the presentation of the first webpage further comprises the second address.

Example 5 may include the method of example 1 and/or some other example herein, wherein the livestream is presented using the first webpage prior to presentation of the first address using the first webpage.

Example 6 may include the method of example 1 and/or some other example herein, further comprising: determining that the livestream has completed; and after completion of the livestream, presenting, using the first webpage, a pre-recorded video of the product.

Example 7 may include the method of example 1 and/or some other example herein, wherein presentation of the product page further comprises a seller profile associated with the first user and information associated with a virtual store from which the third user may purchase the product.

Example 8 may include the method of example 1 and/or some other example herein, further comprising: receiving a query from the third user, the query comprising location information associated with the third user; identifying the first webpage based on the location information; and receiving a fourth user request made by the third user, using the first webpage, to present the first webpage, wherein presenting the first webpage to the third user is based on the fourth user request.

Example 9 may include the method of example 1 and/or some other example herein, further comprising: receiving, from the product page, a selection of the product; and generating a virtual shopping cart based on the selection of the product.

Example 10 may include the method of example 1 and/or some other example herein, wherein presentation of the first webpage comprises a messaging session, the method further comprising: receiving, using the messaging session, a user inquiry associated with the product or the first user.

Example 11 may include the method of example 1 and/or some other example herein, wherein the first webpage is presented concurrently to multiple users of the e-commerce system.

Example 12 may include the method of example 1 and/or some other example herein, further comprising: presenting, using the product page, a conditional transaction associated with the product, wherein presentation of the conditional transaction presents a number of purchases needed to execute the conditional transaction, and a time at which the conditional transaction expires; receiving, from the product page, a selection of a product discount price for the conditional transaction; determining that the number of purchases needed to complete the conditional transaction has been requested prior to expiration of the time; and executing a transaction of the product using the product discount price.

Example 13 may include an electronic commerce system, comprising: a first home page presenting product livestreams; a second home page presenting product pages; and at least one processor coupled to memory, the at least one processor configured to: receive, from a first user of the electronic commerce (e-commerce) system, a first request to a second user of the e-commerce system to present a livestream of a product sold by the first user; send the first request to the second user, the first request comprising a first address to a product page for the product, the product page operated by the first user and presented using the second home page; receive, based on the first request, a second request made by the second user to generate the livestream using the e-commerce system; generate, based on the second request, a first webpage of the e-commerce system, the first webpage presenting the livestream and operated by the second user, and the first webpage presented using the first home page; receive a third request made by the second user to present the first address using the first webpage; present, to a third user of the e-commerce system, the first webpage, wherein the presentation of the first webpage comprises the livestream and the first address; receive, from the first webpage, a selection of the first address made by the third user; and re-direct, based on the selection of the first address, the third user to the product page, wherein the product page presents an option to purchase the product and a second address to a second webpage presenting a second livestream operated by the first user.

Example 14 may include the method of example 13 and/or some other example herein, wherein the first request further comprises a third address to a second product page for a second product sold by the first user, the second product page operated by the first user and presented using the second home page.

Example 15 may include the method of example 14 and/or some other example herein, wherein the second address is absent from the presentation of the first webpage.

Example 16 may include the method of example 14 and/or some other example herein, wherein the at least one processor is further configured to receive a fourth request made by the second user to present the second address using the first webpage, wherein the presentation of the first webpage further comprises the second address.

Example 17 may include a non-transitory computer-readable medium storing computer-executable instructions which when executed by one or more processors result in performing operations comprising: receiving, by an electronic commerce (e-commerce) system comprising a first home page presenting product livestreams and a second home page presenting product pages, from a first user of the e-commerce system, a first request to a second user of the e-commerce system to present a livestream of a product sold by the first user; sending, by the e-commerce system, the first request to the second user, the first request comprising a first address to a product page for the product, the product page operated by the first user and presented using the second home page; receiving, by the e-commerce system, based on the first request, a second request made by the second user to generate the livestream using the e-commerce system; generating, by the e-commerce system, based on the second request, a first webpage of the e-commerce system, the first webpage presenting the livestream and operated by the second user, and the first webpage presented using the first home page; receiving, by the e-commerce system, a third request made by the second user to present the first address using the first webpage; presenting, by the e-commerce system, to a third user of the e-commerce system, the first webpage, wherein the presentation of the first webpage comprises the livestream and the first address; receiving, by the e-commerce system, from the first webpage, a selection of the first address made by the third user; and re-directing, by the e-commerce system, based on the selection of the first address, the third user to the product page, wherein the product page presents an option to purchase the product and a second address to a second webpage presenting a second livestream operated by the first user.

Example 18 may include the non-transitory computer-readable medium of example 17 and/or some other example herein, the operations further comprising: receiving a query from the third user, the query comprising location information associated with the third user; identifying the first webpage based on the location information; and receiving a fourth user request made by the third user, using the first webpage, to present the first webpage, wherein presenting the first webpage to the third user is based on the fourth user request.

Example 19 may include the non-transitory computer-readable medium of example 17 and/or some other example herein, the operations further comprising: receiving, from the product page, a selection of the product; and generating a virtual shopping cart based on the selection of the product.

Example 20 may include the non-transitory computer-readable medium of example 17 and/or some other example herein, the operations further comprising: presenting, using the product page, a conditional transaction associated with the product, wherein presentation of the conditional transaction presents a number of purchases needed to activate the conditional transaction, and a time at which the conditional transaction expires; receiving, from the product page, a selection of the conditional transaction; determining that the number of purchases needed to complete the conditional transaction has been requested prior to expiration of the time; and executing a transaction of the product using a discounted price for the conditional transaction.

Example 21 may include an apparatus comprising means for: receiving, using an commerce (e-commerce) system comprising a first home page presenting product livestreams and a second home page presenting product pages, from a first user of the e-commerce system, a first request to a second user of the e-commerce system to present a livestream of a product sold by the first user; sending the first request to the second user, the first request comprising a first address to a product page for the product, the product page operated by the first user and presented using the second home page; receiving, based on the first request, a second request made by the second user to generate the livestream using the e-commerce system; generating, based on the second request, a first webpage of the e-commerce system, the first webpage presenting the livestream and operated by the second user, and the first webpage presented using the first home page; receiving a third request made by the second user to present the first address using the first webpage; presenting, to a third user of the e-commerce system, the first webpage, wherein the presentation of the first webpage comprises the livestream and the first address; receiving, from the first webpage, a selection of the first address made by the third user; and re-directing, based on the selection of the first address, the third user to the product page, wherein the product page presents an option to purchase the product and a second address to a second webpage presenting a second livestream operated by the first user.

Example 22 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 23 may include an apparatus comprising logic, modules, and/or circuitry to perform one or more elements of a method described in or related to any of examples 1-21, or any other method or process described herein.

Example 24 may include a method, technique, or process as described in or related to any of examples 1-21, or portions or parts thereof.

Example 25 may include an apparatus comprising: one or more processors and one or more computer readable media comprising instructions that, when executed by the one or more processors, cause the one or more processors to perform the method, techniques, or process as described in or related to any of examples 1-21, or portions thereof.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The processes described and shown above may be carried out or performed in any suitable order as desired in various implementations. Additionally, in certain implementations, at least a portion of the processes may be carried out in parallel, creating a co-existence use case. Furthermore, in certain implementations, less than or more than the processes described may be performed.

Certain aspects of the disclosure are described above with reference to flow diagrams of methods, apparatuses, or computer program products according to various implementations. It will be understood that one or more blocks of the flow diagrams, and combinations of blocks in the flow diagrams, can be implemented by computer-executable program instructions. Likewise, some blocks of the flow diagrams may not necessarily need to be performed in the order presented, or may not necessarily need to be performed at all, according to some implementations.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims.

What is claimed is:

1. A method comprising:
receiving, by at least one processor of an electronic commerce (e-commerce) system comprising a first home page presenting product livestreams and a second home page presenting product pages, from a first user of the e-commerce system, a first request to a second user of the e-commerce system to present, using an account of the second user, a livestream of a first product sold by the first user;
sending, by the at least one processor, the first request to the second user, the first request comprising addresses to first product pages comprising a first product page where the first product is sold by the first user and a second product page where a second product not shown in the livestream is sold by the first user, the first product pages operated by the first user and presented using the second home page;
receiving, by the at least one processor, based on the first request, a second request made by the second user to generate the livestream using the e-commerce system and the account of the second user;
generating, by the at least one processor, based on the second request, a first webpage of the e-commerce system, the first webpage presenting the livestream and operated by the second user using the account of the second user, and the first webpage presented using the first home page;
receiving, by the at least one processor, a third request made by the second user to present a first address of the first product page and a second address of the second product page using the first webpage;
presenting, by the at least one processor, to a third user of the e-commerce system, the first webpage, wherein the presentation of the first webpage comprises the livestream, the first address, and the second address;
receiving, by the at least one processor, from the first webpage, a selection of the second address made by the third user; and
re-directing, by the at least one processor, based on the selection of the second address, the third user to the second product page.

2. The method of claim 1, wherein the second product page presents an option to purchase the second product and a third address to a second webpage presenting a second livestream operated by the first user.

3. The method of claim 1, wherein products of the product pages are sold by the first user and at least one additional user, wherein the first product page and the second product page are operated by a user account of the first user, and wherein generating the first webpage does not use the user account of the first user.

4. The method of claim 1, further comprising:
receiving a second selection of the first address made by a fourth user; and
re-directing, based on the second selection of the first address, the fourth user to the first product page.

5. The method of claim 1, wherein the livestream is presented using the first webpage prior to presentation of the first address using the first webpage.

6. The method of claim 1, further comprising:
determining that the livestream has completed; and
after completion of the livestream, presenting, using the first webpage, a pre-recorded video of the first product.

7. The method of claim 1, wherein presentation of the first product page further comprises a seller profile associated with the first user and information associated with a virtual store from which the third user may purchase the first product and the second product.

8. The method of claim 1, further comprising:
receiving a query from the third user, the query comprising location information associated with the third user;
identifying the first webpage based on the location information; and
receiving a fourth user request made by the third user, using the first webpage, to present the first webpage,
wherein presenting the first webpage to the third user is based on the fourth user request.

9. The method of claim 1, further comprising:
receiving, from the second product page, a selection of the second product; and
generating a virtual shopping cart based on the selection of the second product.

10. The method of claim 1, wherein presentation of the first webpage comprises a messaging session, the method further comprising:
receiving, using the messaging session, a user inquiry associated with the first product, the second product, or the first user.

11. The method of claim 1, wherein the first webpage is presented concurrently to multiple users of the e-commerce system.

12. The method of claim 1, further comprising:
presenting, using the second product page, a conditional transaction associated with the second product, wherein presentation of the conditional transaction presents a number of purchases needed to execute the conditional transaction, and a time at which the conditional transaction expires;
receiving, from the second product page, a selection of a product discount price for the conditional transaction;
determining that the number of purchases needed to complete the conditional transaction has been requested prior to expiration of the time; and
executing a transaction of the second product using the product discount price.

13. An electronic commerce system, comprising:
a first home page presenting product livestreams;
a second home page presenting product pages; and
at least one processor coupled to memory, the at least one processor configured to:
receive, from a first user of the electronic commerce system, a first request to a second user of the electronic commerce system to present, using an account of the second user, a livestream of a first product sold by the first user;
send the first request to the second user, the first request comprising addresses to first product pages comprising a first product page where the first product is sold by the first user and a second product page where a second product not shown in the livestream is sold by the first user, the first product pages operated by the first user and presented using the second home page;
receive, based on the first request, a second request made by the second user to generate the livestream using the electronic commerce system and the account of the second user;
generate, based on the second request, a first webpage of the electronic commerce system, the first webpage presenting the livestream and operated by the second user using the account of the second user, and the first webpage presented using the first home page;
receive a third request made by the second user to present a first address of the first product page and a second address of the second product page using the first webpage;
present, to a third user of the electronic commerce system, the first webpage, wherein the presentation of the first webpage comprises the livestream, the first address, and the second address;
receive, from the first webpage, a selection of the second address made by the third user; and
re-direct, based on the selection of the second address, the third user to the second product page.

14. The electronic commerce system of claim 13, wherein the second product page presents an option to purchase the second product and a third address to a second webpage presenting a second livestream operated by the first user.

15. The electronic commerce system of claim 14, wherein products of the product pages are sold by the first user and at least one additional user, wherein the first product page and the second product page are operated by a user account of the first user, and wherein generating the first webpage does not use the user account of the first user.

16. The electronic commerce system of claim 14, wherein the at least one processor is further configured to:
receive a second selection of the first address made by a fourth user; and
re-direct, based on the second selection of the first address, the fourth user to the first product page.

17. A non-transitory computer-readable medium storing computer-executable instructions which when executed by one or more processors result in performing operations comprising:
receiving, by an electronic commerce (e-commerce) system comprising a first home page presenting product livestreams and a second home page presenting product pages, from a first user of the e-commerce system, a first request to a second user of the e-commerce system to present, using an account of the second user, a livestream of a first product sold by the first user;
sending the first request to the second user, the first request comprising addresses to first product pages comprising a first product page where the first product is sold by the first user and a second product page where a second product not shown in the livestream is sold by the first user, the first product pages operated by the first user and presented using the second home page;
receiving, based on the first request, a second request made by the second user to generate the livestream using the e-commerce system and the account of the second user;
generating, based on the second request, a first webpage of the e-commerce system, the first webpage presenting the livestream and operated by the second user using the account of the second user, and the first webpage presented using the first home page;
receiving, a third request made by the second user to present a first address of the first product page and a second address of the second product page using the first webpage;
presenting, to a third user of the e-commerce system, the first webpage, wherein the presentation of the first webpage comprises the livestream, the first address, and the second address;
receiving, from the first webpage, a selection of the second address made by the third user; and
re-directing, based on the selection of the second address, the third user to the second product page.

18. The non-transitory computer-readable medium of claim 17, wherein the second product page presents an option to purchase the second product and a third address to a second webpage presenting a second livestream operated by the first user.

19. The non-transitory computer-readable medium of claim 17, wherein products of the product pages are sold by the first user and at least one additional user, wherein the first product page and the second product page are operated by a user account of the first user, and wherein generating the first webpage does not use the user account of the first user.

20. The non-transitory computer-readable medium of claim 17, the operations further comprising:
receiving a second selection of the first address made by a fourth user; and
re-directing, based on the second selection of the first address, the fourth user to the first product page.
